(19) United States
(12) Patent Application Publication
(10) Pub. No.: US 2021/0304101 A1
(43) Pub. Date: Sep. 30, 2021

(54) SERVICE LINKING DEVICE AND NOTIFICATION METHOD

(71) Applicant: Nippon Telegraph and Telephone Corporation, Tokyo (JP)

(72) Inventors: Nobuo Onai, Tokyo (JP); Naoyuki Tanji, Tokyo (JP); Naoki Take, Tokyo (JP); Kensuke Takahashi, Tokyo (JP); Hiroyuki Tanaka, Tokyo (JP); Hiroshi Kato, Tokyo (JP); Hiroyuki Yazaki, Tokyo (JP)

(21) Appl. No.: 17/053,940

(22) PCT Filed: Apr. 23, 2019
(86) PCT No.: PCT/JP2019/017159

§ 371 Date: Nov. 9, 2020

(30) Foreign Application Priority Data
May 10, 2018 (JP) 2018-091180

(51) Int. Cl. G06Q 10/06; H04L 29/06

(52) U.S. Cl. CPC G06Q 10/06316; H04L 67/40; G06Q 10/063114; G06Q 10/06315

(57) ABSTRACT

[Problem] The convenience of associated services is improved.

[Solution] A service association apparatus 1 that executes associated services which are a plurality of types of services associated with each other includes a work API unit 10 that receives a request including a service order of the associated services from a service provider, a plurality of adapters 31 to 33 that are provided for each of services constituting the associated services and execute an API of the service to process a service order portion for the service in the service order, and a notification information generation unit 11 that notifies the service provider of a completion notification of the service order in a case where the processing of the service order portion is entirely completed.

### TECHNICAL FIELD

The present disclosure relates to a service association apparatus and a notification method.

### BACKGROUND ART

Non Patent Literature 1 discloses a “method of combining networks, clouds, and applications of plural operators to flexibly achieve compatibility with new services or APIs when collectively constructing associated services”. API is an abbreviation for “application programmable interface”.

### CITATION LIST

### Non Patent Literature

Non Patent Literature 1: Kensuke Takahashi and 3 others, “Architecture for making service association between plural operators flexible,” Proceedings of the IEICE General Conference CD-ROM, Japan, Aug. 19, 2017, Volume 2017, Issue: Society Conference, Page: ROMBUNNO.B-14-8

### SUMMARY OF THE INVENTION

### Technical Problem

In a case where a service order related to associated services, which are a plurality of types of services associated with each other, is issued from a service provider to a wholesale service provider of each service, the service provider is notified of a service order response from each wholesale service provider. However, even when all wholesale service providers have given a notification, it cannot be determined that the entire service order has been completed. In the related art, the completion of the entire service order is confirmed individually by an operator of a system in which associated services are provided. For this reason, it takes time to ascertain the completion of the entire service order, and thus there is a problem in that the convenience of associated services for a service provider is impaired. Non Patent Literature 1 does not describe or suggest countermeasures for such a problem.

In view of such circumstances, an advantage of some aspects of the present disclosure is to improve the convenience of associated services for a service provider.

### Means for Solving the Problem

In order to solve the problem, the invention according to a first aspect is a service association apparatus that executes associated services which are a plurality of types of services associated with each other, the service association apparatus including a reception unit configured to receive a request including a service order of the associated services from a service provider, a plurality of adapters provided for each of services constituting the associated services and configured to execute an API of the service to process a service order portion for the service in the service order, and a notification unit configured to notify the service provider of a completion notification of the service order in a case where the processing of the service order portion is entirely completed.

In addition, the invention according to a fifth aspect is a notification method in a service association apparatus that executes associated services which are a plurality of types of services associated with each other, the notification method including causing the service association apparatus to receive a request including a service order of the associated services from a service provider, causes each of adapters provided for each of services constituting the associated services to execute an API of the service, to process a service order portion for the service in the service order, and notify the service provider of a completion notification of the service order in a case where the processing of the service order portion is entirely completed.

According to the first and fifth aspects, the service provider can reliably and immediately ascertain that the entire service order issued by the service provider is completed and can eliminate the necessity of individual confirmation of the completion of the entire service order by an operator of a system where the associated services are provided. Thus, it is possible to improve the convenience of the associated services for a service provider.

The invention according to a second aspect is the service association apparatus according to the first aspect. A storage unit of the service association apparatus stores request source information regarding the service provider that issues the request including the service order, and the request source information includes a filtering condition for limiting the completion notification of the service order issued by the notification unit.

According to the second aspect, it is possible to achieve a completion notification of a service order having a different demand from each user of the service association apparatus.

In addition, the invention according to a third aspect is the service association apparatus according to the second aspect, and the filtering condition is a condition for determining a notification destination of the completion notification of the service order.

According to the third aspect, a completion notification of a service order can be issued to a desired notification destination.

In addition, the invention according to a fourth aspect is the service association apparatus according to the second aspect, and the filtering condition is a condition for determining a notification trigger for the completion notification of the service order.

According to the fourth aspect, it is possible to issue a completion notification of a service order with a desired notification trigger.

### Effects of the Invention

According to the present disclosure, it is possible to improve the convenience of associated services for a service provider.

### BRIEF DESCRIPTION OF DRAWINGS

FIG. 1 is an example of a functional configuration diagram of a service association apparatus of the present embodiment.

FIG. 2 is a flowchart of associated services construction process.

### DESCRIPTION OF EMBODIMENTS

Hereinafter, an embodiment of the present disclosure will be described with reference to the drawings.

Configuration

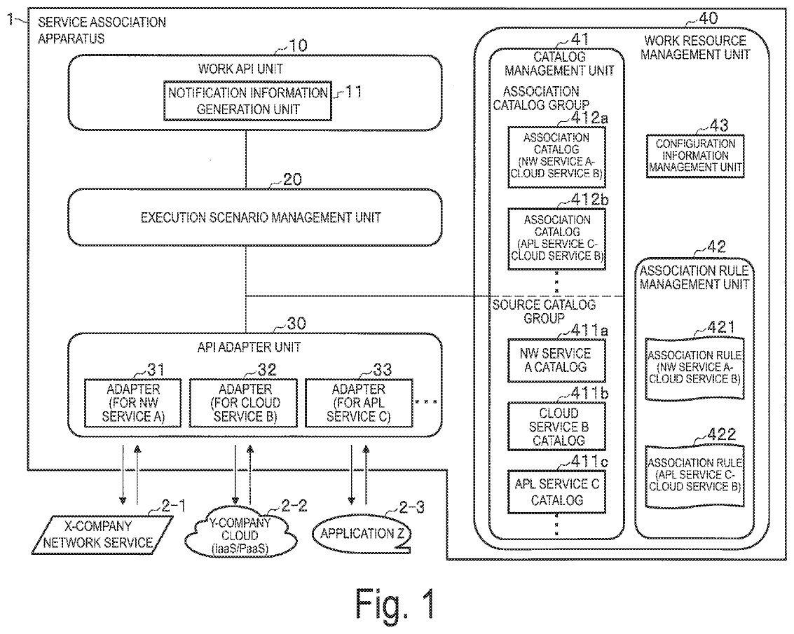

A service association apparatus 1 according to the present embodiment illustrated m FIG. 1 is an apparatus that executes associated services which are a plurality of types of services associated with each other. The service association apparatus 1 has, for example, a catalog driven architecture that operates using a catalog describing service specifications. The service association apparatus 1 is a computer that includes hardware such as an input/output unit (not illustrated) constituted by an interface (I/F) for input and output, a storage unit (not illustrated) constituted by a hard disk, a flash memory, a Random Access Memory (RAM), or the like, and a control unit constituted by a Central Processing Unit (CPU) or the like. The control unit executes the above-described processing by, for example, expanding programs stored in the storage unit in a storage region of the storage unit and executing the programs. The service association apparatus 1 of the present embodiment can realize cooperation between such software and hardware.

In FIG. 1, as a plurality of types of services, an X-company network service 2-1, a Y-company cloud 2-2 of Infrastructure as a Service (Iaas) or Platform as a service (Paas), and an app Z 2-3 (“app” stands for “application (APL)”) are illustrated. The X-company network service 2-1 is a service provided by a company X (NW service A) which is a wholesale service provider. The Y-company cloud 2-2 is a service provided by a company Y (cloud service B) which is a wholesale service provider. The app Z 2-3 is a service provided by a company Z (APL service C) which is a wholesale service provider. However, the types of services used in the present disclosure are not limited thereto. In the present embodiment, two or more of the X-company network 2-1, the Y-company cloud 2-2, and the app Z 2-3 can be associated with each other to form one associated service.

The service association apparatus 1 includes a work API unit 10 (reception unit), an execution scenario management unit 20, an API adapter unit 30, and a work resource management unit 40.

The work API unit 10 receives a service order from a service provider. The service provider may include a service provider terminal (not illustrated) which is communicatively connected to the service association apparatus 1 and may transmit a request including a predetermined service order to the service association apparatus 1. For convenience of description, processing performed by a service provider terminal (transmission of a request, reception of information, and the like) will be described as processing performed by a service provider. The work API unit 10 includes a notification information generation unit 11 (notification unit). The notification information generation unit 11 generates predetermined notification information in accordance with a response indicating the completion of a service order and transmits the generated notification information to a service provider. The response will be described later.

The execution scenario management unit 20 manages various scenarios in which a processing procedure of the service order is described, and executes a scenario corresponding to the service order. The above-described scenarios include, for example, a scenario for collectively constructing the services of the service providers, and a scenario for performing setting for monitoring a wholesale service provider, and the like, but are not limited thereto.

The API adapter unit 30 executes an API of a service of a wholesale service provider to process a service order. The API adapter unit 30 includes adapters 31 to 33, but is not limited thereto. The adapter 31 is an adapter for the NW service A and executes an API of the X-company network 2-1 to process a service order addressed to the company X. The adapter 32 is an adapter for the cloud service B and executes an API of the Y-company cloud 2-2 to process a service order addressed to the company Y. The adapter 33 is an adapter for the APL service C and executes an API of the app Z 2-3 to process a service order addressed to the company Z.

The API adapter unit 30 also performs processing in response to an order for executing an API of an adapter (adapters 31 to 33) of a corresponding wholesale service from the execution scenario management unit 20 and returns the processing result to the execution scenario management unit 20. Each of the specified plurality of adapters processes a service order portion corresponding to the adapter in a service order of associated services. For example, as for a service order of associated services which are the NW service A and the cloud service B associated with each other, the adapter 31 processes the portion of the NW service A in the service order of the associated services, and the adapter 32 processes the portion of the cloud service B in the service order of the associated services.

The work resource management unit 40 stores and manages various resources related to the execution of a (single) service and associated services. The work resource management unit 40 includes a catalog management unit 41, an association rule management unit 42, and a configuration information management unit 43.

The catalog management unit 41 manages a catalog that defines the specifications of a service. The catalog is stored in, for example, a storage unit of the service association apparatus 1. Catalogs managed by the catalog management unit 41 can be classified into source catalogs and association catalogs. For convenience of description, the source catalog may simply be referred to as a “catalog.”

A source catalog managed by the catalog management unit 41 is a catalog that defines the specifications of a service which is a target of the service association apparatus 1 and is provided for each of wholesale service providers. A source catalog (group) managed by the catalog management unit 41 includes an NW service A catalog 411a, a cloud service B catalog 411b, and an APL service C catalog 411c, but is not limited thereto. The NW service A catalog 411a is a catalog that defines the specifications of the NW service A. The cloud service B catalog 411b is a catalog that defines the specifications of the cloud service B. The APL service C catalog 411c is a catalog that defines the specifications of the APL service C.

In addition, an association catalog (group) managed by the catalog management unit 41 is a catalog that defines the specifications of associated services which are the target of the service association apparatus 1. The association catalog can be created by combining a plurality of catalogs of the services constituting the associated services. The association catalogs managed by the catalog management unit 41 include association catalogs 412a and 412b, but are not limited thereto. The association catalog 412a is a catalog that defines the specifications of the associated services which are the NW service A and the cloud service B associated with each other and is created by combining the NW service A catalog 411a and the cloud service B catalog 411b. The association catalog 412b is a catalog that defines the specifications of the associated services which are the APL service C and the cloud service B associated with each other and are created by combining the APL service C catalog 411c and the cloud service B catalog 411b.

The association rule management unit 42 manages an association rule serving as a regulation related to an association operation between services constituting the associated services. One or a plurality of association rules can be provided for each association catalog. Association rules managed by the association rule management unit 42 include association rules 421 and 422, but are not limited thereto. The association rule 421 is a regulation related to an association operation between the NW service A and the cloud service B that constitute the associated services. The association rule 422 is a regulation related to an association operation between the APL service C and the cloud service B that constitute associated services.

The configuration information management unit 43 manages information for generating notification information by the notification information generation unit 11 as configuration information. Configuration information includes request source information (to be described later) indicating a service provider transmitting a request including a service order, but is not limited thereto. The configuration information management unit 43 can request, through the execution scenario management unit 20, the notification information generation unit 11 to issue a completion notification of a service order on the basis of a completion response of a service order portion for each of wholesale service providers which constitutes a service order of associated services.

Meanwhile, resources managed by the work resource management unit 40 are not limited to the catalog managed by the catalog management unit 41, the association rule managed by the association rule management unit 42, and the configuration information managed by the configuration information management unit 43 and include various information.

Completion Notification of Service Order of Associated Services Through Associated Services Construction Process

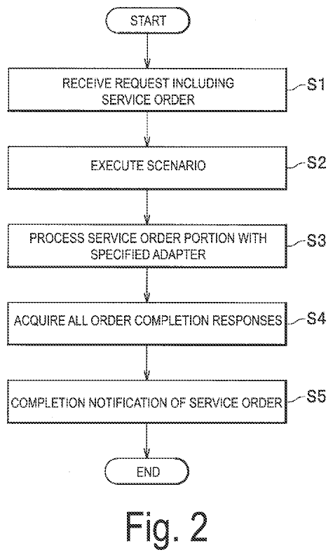

Associated services construction processing of the service association apparatus 1 of the present embodiment will be described with reference to FIG. 2. This processing begins in a case where a request including a service order for constructing associated services is issued from a service provider.

First, the work API unit 10 receives and accepts a request including the service order for constructing the associated services (step S1). Next, the execution scenario management unit 20 executes a scenario for constructing the associated services in response to the service order (step S2). When the scenario is executed, the catalog management unit 41 and the association rule management unit 42 of the work resource management unit 40 are referred to, and the service association apparatus 1 operates in accordance with an association catalog of target associated services and an association rule between a plurality of types of services constituting the target associated services. In addition, as a result of the execution of the scenario, the types of services constituting the associated services are determined. The execution scenario management unit 20 notifies the configuration information management unit 43 of the work resource management unit 40 of the determined types of services.

Next, the API adapter unit 30 specifies an adapter to be processed in accordance with the scenario of the associated services received from the execution scenario management unit 20. The specified adapter executes an API of a corresponding service to process a corresponding service order portion in the service order of the associated services (step S3). When the processing of the service order portion is completed by each of the adapters, the API adapter unit 30 receives an order completion response indicating that the processing of the service order portion has been completed from each of (terminals of) corresponding wholesale service providers.

Next, the configuration information management unit 43 of the work resource management unit 40 acquires all order completion responses of the service order portions from the API adapter unit 30 (step S4). Each order completion response is acquired asynchronously. The configuration information management unit 43 determines that the entire service order for constructing the associated services has been completed in a case where the configuration information management unit 43 can acquire all of the order completion responses of the service order portions on the basis of the types of services notified in advance from the execution scenario management unit 20 (step S2) in response to the service order for constructing the associated services. Meanwhile, the work resource management unit 40 updates a database of various resources managed by the work resource management unit 40 in response to the acquired order completion response. The configuration information management unit 43 requests, via the execution scenario management unit 20, the notification information generation unit 11 to issue a completion notification of a service order. In addition, the configuration information management unit 43 registers a configuration of the constructed associated services as configuration information. The configuration of the associated services is, for example, information regarding a network apparatus or a server which is located in a network where the associated services are provided.

When the notification information generation unit 11 of the work API unit 10 receives a request of the configuration information management unit 43, the notification information generation unit 11 generates notification information for a service provider having issued a request including a service order for constructing the associated services and notifies the service provider of the completion of the service order (step S5). Thus, the service provider can reliably and immediately ascertain that the entire service order given by the service provider has been completed and can eliminate the necessity of individual confirmation of the completion of the entire service order by an operator of a system in which the associated services are provided (an operator of the service association apparatus 1, or the like). As a result, it is possible to improve the convenience of the associated services for a service provider.

The above description relates to a service order for constructing associated services. However, the present disclosure is not limited to the construction and also applies to the management of the associated services, and the like.

Registration of Request Source Information

The service association apparatus 1 can register request source information indicating a service provider that issues a request including a service order. The request source information includes ID information for identifying the service provider as a request source. The service provider may include attribute information indicating attributes related to the service provider in a request to be transmitted to the service association apparatus 1. The attribute information includes importance information indicating the importance of an event indicated in notification information generated by the notification information generation unit 11 in response to a request including a service order, notification filter information for limiting notification content indicated in the notification information, and notification destination information indicating a notification destination URL of the notification information, but is not limited thereto. The attribute information constitutes a filtering condition for limiting a completion notification of a service order which is issued by the notification information generation unit 11. The above-described importance information, notification filter information, and notification destination information are also types of filtering conditions.

The service association apparatus 1 manages the status of a scenario execution situation in order to process the service order of the associated services. The status of a scenario execution situation can be represented using, for example, an event type and an event. An “event type” is a type of processing when an API of a service constituting the associated services is executed. A specific example of the event type is, for example, “Ticket Status Change Notification” in an API of a travel ticket. The “event” is the content of processing when an API of a service constituting the associated services is executed, and is determined for each event type. In a case where an event type is “Ticket Status Change Notification”, specific examples of an event include, for example, “Acknowledgement” and “InProgress”. In the importance information of the attribute information, importance is set for each event.

The notification destination URL indicated by the notification destination information can be, for example, a URL of a site disclosed by the service provider issuing the request including a service order, but is not limited thereto. In addition, the number of notification destination URLs is not limited to one but may be two or more.

The work API unit 10 of the service association apparatus 1 can analyze a request received from a service provider (the request may or may not include a service order) to generate request source information and can register the generated request source information in the work resource management unit 40. The work resource management unit 40 includes a request source table (not illustrated) for managing request source information and registers the request source information acquired from the work API unit 10 in the request source table. The work API unit 10 can add attribute information to the request source information, and the work resource management unit 40 can register the attribute information in the request source table in association with the request source information. The work resource management unit 40 notifies, via the work API unit 10, the service provider of the completion of registration of the request source information. The request source table is stored in the storage unit of the service association apparatus 1.

The service association apparatus 1 can achieve the completion notification of a service order having a different demand from each user of the service association apparatus, using filtering conditions indicated in attribute information added to the request source information.

Distribution of Notification Destination

The service association apparatus 1 can determine a notification destination of the notification information including the completion notification of the service order of the associated services. For example, when the work resource management unit 40 registers the request source information at the time of the completion of a new service order, the work resource management unit 40 requests the notification information generation unit 11 to transmit notification information to a notification destination URL indicated in notification destination information among pieces of attribute information added to the registered request source information. The notification information generation unit 11 transmits the completion notification of the service order to the notification destination URL indicated in the notification destination information. As a result, the completion notification of the service order can be issued to a desired notification destination.

Limitation of Notification Content

The service association apparatus 1 can limit (filter) the notification content of notification information including a completion notification of the service order of the associated services. For example, when the work resource management unit 40 registers the request source information at the time of the completion of the new service order, the work resource management unit 40 requests the notification information generation unit 11 to transmit the notification information in accordance with the notification filter information in the attribute information which is added to the registered request source information. The notification information generation unit 11 limits the notification content when notifying the notification destination of a completion notification of the service order.

For example, a case is assumed where some of wholesale service providers of the services constituting the associated services have succeeded in order processing and an order completion response has been issued, but the remaining wholesale service providers have failed in order processing and an order failure response has been issued. In this case, the service association apparatus 1 may notify the service provider of both an order completion response and an order failure response, but the service association apparatus may determine that the notification of the order completion response is unnecessary and may notify the service provider of only a location where the cause of the order processing failure is identified. The service association apparatus 1 can describe such notification limitation in the notification filter information. In addition, the service association apparatus 1 can describe information which is not required to be notified in a case where a predetermined condition is satisfied in notification filter information in combination with the predetermined condition.

Further, in a case where conditions of an event type are described in a request including the service order of the associated services, which has been received from the service provider, after the request source information is registered, the notification information generation unit 11 can notify the service provider of only information corresponding to the event type as notification information to be notified to the service provider. Further, in a case where conditions indicated in attribute information in addition to the conditions of the event type are described in a request including the service order of the associated services, the notification information generation unit 11 can notify the service provider of only a portion satisfying the conditions indicated in the attribute information in the information corresponding to the event type as notification information to be notified to the service provider.

In a case where no conditions are described in a request including the service order of the associated services, which has been received from the service provider after the request source information is registered or in a case where “no conditions” is specified, the notification information to be notified to the service provider is all the information with no limitation. As a result, it is possible to give a completion notification of a service order with desired notification content.

Notification Trigger of Notification Information

The service association apparatus 1 can determine a notification trigger that triggers the notification information generation unit 11 to notify a service provider of the notification information. For example, when the work resource management unit 40 registers request source information, the work resource management unit 40 requests the notification information generation unit 11 to transmit notification information in accordance with a notification trigger indicated in attribute information which is added to the registered request source information. As a result, it is possible to issue a completion notification of a service order with a desired notification trigger.

For example, as described above, a case is assumed where the configuration information management unit 43 of the work resource management unit 40 requests the notification information generation unit 11 to acquire all order completion responses of service order portions in response to the service order for constructing the associated services and to issue the completion notification of the service order. In this case, upon receiving the request as the trigger, the work API unit 10 confirms the completion of an update of a database of various resources according to the order completion response of the service order portion for the work resource management unit 40. After the completion of the update of the database of various resources is confirmed, the notification information generation unit 11 notifies the service provider of the notification information. In this manner, when a plurality of services are associated with each other, the information notification may be issued after the completion of construction of all the associated services is confirmed.

In addition, when every order completion response of the service order portion is finally issued, the notification information generation unit 11 may notify the service provider of the notification information even when the order of the service order portion is being processed. That is, the notification information generation unit 11 may issue the information notification even in a case where the construction of a portion of the associated services is not yet completed when associating a plurality of services with each other. For example, in a case where an interface on a wholesale service provider side is not equipped with a notification function, such a notification scheme may be adopted.

Also in operations such as the construction of equipment and charging associated with the execution of the associated services, it is necessary to notify the service provider of predetermined information (information notification). There are a number of triggers for the information notification, including, for example, a case where the processing of the service order of the associated services reaches a certain progress stage, a case where the processing of a trouble ticket reaches a certain progress stage, a case where SLA violation is determined, a case where the amount of use of a product or a service is calculated, a case where charging is performed, a case where a catalog is updated. These timings may be described in attribute information as notification triggers.

The service association apparatus 1 can set the necessity of notification, a notification destination (an individual or an organization), and importance for each notification information to be notified to the service provider. In this case, it is assumed that each user of the service association apparatus 1 has a different demand for the control of each information notification, and thus may perform definition using a predetermined external rule to achieve detailed settings. For example, the external rule is communicatively connected to the service association apparatus 1. The external rule is stored in an external apparatus capable of inputting information to the service association apparatus 1 and can be edited by an external apparatus. For example, the control of the information notification performed with an external rule can be achieved by defining importance, necessity of notification, and a notification destination for each event which is determined for each event type.

Others

Hitherto, the embodiment of the present disclosure has been described. However, the present disclosure is not limited to the above embodiment, and can be appropriately changed in a range without departing from the gist of the present disclosure. For example, in a case where processing for reacquiring necessary information is required when the notification information generation unit 11 generates notification information, the notification information generation unit 11 can request the work resource management unit 40 to reacquire the information. In addition, normally, the permission of access to resources managed by the work resource management unit 40 is different for each user of the service association apparatus 1 (including a service provider and a wholesale service provider). For this reason, the work resource management unit 40 can edit resource information according to an access right of each user of the service association apparatus 1.

A technique obtained by suitably combining various techniques described in the present embodiment may be implemented.

Software described in the present embodiment may be implemented as hardware, and hardware may be implemented as software.

In addition, hardware, software, the flowchart, and the like can be suitably changed without departing from the spirit of the present disclosure.

### REFERENCE SIGNS LIST

1 Service association apparatus
10 work API unit (reception unit)
11 Notification information generation unit (notification unit)
20 execution scenario management unit
30 API adapter unit
40 work resource management unit
41 Catalog management unit
42 association rule management unit
43 configuration information management unit

1. A service association apparatus that executes associated services comprising a plurality of types of services associated with each other, the service association apparatus comprising:
a reception unit configured to receive a request including a service order for the associated services from a service provider;
a plurality of adapters provided for each service among the associated services and configured to execute an API of the service to process a service order portion for the service in the service order; and
a notification unit configured to notify the service provider of a completion notification of the service order in a case where the processing of the service order portion is entirely completed.

2. The service association apparatus according to claim 1, further comprising:
a storage unit of the service association apparatus, wherein the storage unit stores request source information regarding the service provider that issues the request including the service order,
wherein the request source information includes a filtering condition for limiting the completion notification of the service order issued by the notification unit.

3. The service association apparatus according to claim 2, wherein the filtering condition is a condition for determining a notification destination of the completion notification of the service order.

4. The service association apparatus according to claim 2, wherein the filtering condition is a condition for determining a notification trigger for the completion notification of the service order.

5. A notification method for a service association apparatus that executes associated services comprising a plurality of types of services associated with each other, the notification method comprising:
cause the service association apparatus to perform operations of:
receive a request including a service order for of the associated services from a service provider;
cause each of a plurality of adapters provided for each service among the associated services to execute an API of the service, to process a service order portion for the service in the service order; and
notify the service provider of a completion notification of the service order in a case where the processing of the service order portion is entirely completed.
